(19) United States
(12) Patent Application Publication
(10) Pub. No.: US 2002/0172059 A1
(43) Pub. Date: Nov. 21, 2002

(54) Bias control circuit

(75) Inventors: Yoshitaka Shinomiya, Tokyo (JP); Junichi Nakagawa, Saitama (JP)

Correspondence Address: FRISHAUF, HOLTZ, GOODMAN, LANGER & CHICK, P.C., 767 THIRD AVENUE, NEW YORK, NY, 10017-2023, US

(73) Assignee: Mobile Communications Tokyo Inc., Tokyo (JP)

(21) Appl. No.: 10/081,582

(22) Filed: Feb. 22, 2002

(30) Foreign Application Priority Data
Feb. 28, 2001 (JP) 2001-054222

(51) Int. Cl. H02M 3/18

(52) U.S. Cl. 363/59

(57) ABSTRACT

A bias control circuit includes a voltage conversion circuit that includes a differential amplifier, constituted by two pairs of transistors for receiving a control voltage at its inverting input terminal, and an output transistor for outputting, as a bias control voltage for a high-frequency power amplifier, an output voltage obtained by subjecting a non-inverting output voltage of the differential amplifier to low impedance conversion. The voltage conversion circuit is realized by a voltage follower circuit that performs the entire feedback of the output voltage of the output transistor to a non-inverting input terminal of the differential amplifier and the feedback of an inverting output voltage to the inverting input terminal of the differential amplifier.

### BACKGROUND OF THE INVENTION

1. Technical Field

The present invention relates to a bias control circuit for a high-frequency power amplifier, and more particularly, to a bias control circuit suited to control a bias current for a high-frequency power amplifier to thereby vary the output of the power amplifier and, by extension, the transmission output of a cellular phone mounted with such a high-frequency power amplifier.

2. Related Art

The transmission output of a cellular phone is not required to be always maintained at its maximum level, and may be decreased if the distance between the cellular phone and a base station for the other end of the phone line is small. In general circumstances, a cellular phone is operable with stability at a transmission output level which is one-tenth of the maximum level. By decreasing the transmission output in this manner, waste power consumption can be prevented and the best possible use of capacity of a power source secondary battery of the cellular phone can be achieved, to thereby permit the cellular phone to operate for a long time.

Generally, the transmission output of a cellular phone is variably controlled by adjusting the gain of a high-frequency power amplifier mounted in the cellular phone. For instance, such gain adjustment is performed by adjusting a bias current for a transistor constituting the high-frequency power amplifier. Specifically, as shown in FIG. 3, the base input current for a gain-adjusting transistor in a transistor circuit constituting a high-frequency power amplifier 1 is varied in accordance with an externally supplied control voltage V_{GC}, e.g., a control voltage V_{GC} indicative of a transmission output demanded by a base station to a cellular phone, whereby the emitter current I_{E} of the transistor 2 is adjusted to vary the output of the high-frequency power amplifier 1 and, by extension, the transmission output of the cellular phone.

In order to adjust the transmission output while maintaining the linearity thereof, the output impedance of the bias control circuit must be made as small as possible. Further, a cellular phone is ordinarily provided with a power source battery such as a manganese battery or a lithium battery from which a DC power voltage of 1.5 or 3.0 volts is obtainable, and hence the high-frequency power amplifier as well as the bias control circuit must be configured so as to be operable with such a DC voltage.

To satisfy these requirements, as exemplarily shown in FIG. 3, a conventional bias control circuit is comprised of a common-emitter transistor 3 for effecting low-impedance conversion of the control voltage V_{GC} and a diode-connected transistor 4 that is adapted to be driven by the transistor 3 so as to act as a current mirror source.

According to the bias control circuit composed of such a current mirror circuit and configured to have a sufficiently decreased output impedance, however, a large amount of electric current is permitted to flow through the transistor 4 in the bias control circuit, which current constitutes a useless current that does not contribute to the base input current for the transistor 2, and thus causing waste power consumption.

### SUMMARY OF THE INVENTION

An object of the present invention is to provide a bias control circuit which is simple in construction and capable of effectively adjusting a bias current for a high-frequency power amplifier, while suppressing waste power consumption, thereby variably controlling the output power of the high-frequency power amplifier.

Another object of the present invention is to provide a bias control circuit which is operable with a DC power source voltage supplied from a battery and capable of variably controlling the output power of a high-frequency power amplifier and, by extension, e.g., the transmission output of a cellular phone mounted with such a high-frequency power amplifier, with excellent linearity and without waste power consumption.

According to the present invention, there is provided a bias control circuit for controlling a bias current of a high-frequency power amplifier. The bias control circuit comprises a voltage conversion circuit for receiving a control voltage and for converting the control voltage into a bias control voltage to be supplied to the high-frequency power amplifier. The voltage conversion circuit includes: a two-stage differential amplifier, constituted by two pairs of amplifying transistors and having an inverting input terminal, a non-inverting input terminal, an inverting output terminal and a non-inverting output terminal, for receiving the control voltage at the inverting input terminal and for outputting an inverting output voltage and a non-inverting output voltage from the inverting output terminal and the non-inverting output terminal, respectively; an output transistor for effecting low impedance conversion for the non-inverting output voltage of the two-stage differential amplifier to obtain an output voltage and for outputting the thus obtained output voltage, as the bias control voltage, to the high-frequency power amplifier; a feedback circuit for making entire feedback of the output voltage to the non-inverting input terminal of the two-stage differential amplifier and feedback of the inverting output voltage of the two-stage differential amplifier to the inverting input terminal thereof; and a diode-connected biasing transistor for regulating base voltages of the pair of amplifying transistors constituting a first amplifier stage of the two-stage differential amplifier.

In the voltage conversion circuit provided in the bias control circuit of this invention, the control voltage is applied to the inverting input terminal of the two-stage differential amplifier, and the non-inverting output voltage of the two-stage differential amplifier is subjected to low impedance conversion. The resulting output voltage is, on one hand, supplied as the bias control voltage to the high-frequency power amplifier, and, on the other hand, is subject to entire feedback to the non-inverting input terminal of the two-stage differential amplifier. Further, the non-inverting output voltage of the two-stage differential amplifier is fed back to the inverting input terminal of the two-stage differential amplifier. The bias control circuit is realized as a voltage follower circuit having a low output impedance. Thus, the bias control circuit of this invention can decrease a useless current to thereby suppress waste power consumption and is simple in construction. Moreover, the bias control circuit that applies the bias control voltage to the high-frequency power amplifier can variably control the output power of the high-frequency power amplifier with efficiency and adequate linearity.

Preferably, the high-frequency power amplifier for use with the bias control circuit is comprised of a transistor. More preferably, the high-frequency power amplifier is configured to have output power that varies in accordance with a base-emitter voltage applied to the transistor constituting the high-frequency power amplifier. The bias control circuit optimally controls the bias current of the high-frequency power amplifier so that desired output power corresponding to the control voltage is output from the high-frequency power amplifier. More preferably, the bias control circuit is comprised of a transistor integrated circuit and is formed into an integrated circuit together with the transistor constituting the high-frequency power amplifier.

With this preferred arrangement, a bias control circuit is provided, which is suited to be mounted to a cellular phone together with a high-frequency power amplifier.

More preferably, the bias control circuit is constituted by a transistor integrated circuit that is operable with a DC power source voltage of 1.5 or 3.0 volts.

According to the preferred arrangement, the bias control circuit is operable with a DC power source voltage of 1.5 or 3.0 volts generated by a Manganese battery or a lithium battery, and is thus suited to be mounted to a cellular phone equipped with such a power source battery.

More preferably, at least part of the transistor integrated circuit constituting the bias control circuit, especially the voltage conversion circuit, is comprised of transistors that are configured to have a maximum base-emitter voltage which is approximately half the DC power source voltage supplied from a battery.

According to the preferred arrangement, the bias control circuit can be easily formed into an integrated circuit by stacking, in two levels at the maximum, the transistors that constitute at least part of the bias control circuit. The resulting bias control circuit is operable with a DC power source voltage supplied from a battery. For instance, the bias control circuit constituted by heterojunction-bipolar transistors (HBTS) whose maximum base-emitter voltage is approximately 1.4 volts can be operated with a DC power source voltage of approximately 3 volts generated by a lithium battery. The bias control circuit constituted by Si bipolar transistors, e.g., SiGe-HBTs, whose maximum base-emitter voltage is about 0.7 volts can be driven by a DC power source voltage of about 1.5 volts generated by a Manganese battery.

Preferably, the bias control circuit of the present invention further comprises a temperature compensation circuit for applying a temperature compensation voltage to the inverting input terminal of the two-stage differential amplifier. More preferably, the temperature compensation circuit comprises: a resistor bridge circuit including a diode-connected temperature-sensing transistor connected in series therewith; an error amplifier, comprised of a pair of amplifying transistors, for amplifying a bridge output of the resistor bridge circuit to obtain an error voltage; and an output transistor for effecting low-impedance conversion of an output voltage of the error amplifier, to thereby generate a temperature compensation voltage. More preferably, the temperature compensation circuit and the voltage conversion circuit are each constituted by a transistor integrated circuit, and the temperature compensation circuit is formed into an integrated circuit together with the voltage conversion circuit.

According to the preferred arrangement, the temperature compensation for the bias control circuit can be carried out with ease and with efficiency. Such a bias control circuit is suited to be mounted to a cellular phone which may be used under various temperature circumstances.

### BRIEF DESCRIPTION OF THE DRAWINGS

FIG. 1 is a circuit diagram of a bias control circuit according to an embodiment of the present invention;

FIG. 2 is a schematic circuit diagram showing an equivalent circuit of the bias control circuit shown in FIG. 1; and

FIG. 3 is a schematic circuit diagram showing a typical example of a conventional bias control circuit that employs a current mirror circuit.

### DETAILED DESCRIPTION

In the following, a bias control circuit according to an embodiment of the present invention will be explained.

The bias control circuit is employed for variable control of the output of a high-frequency power amplifier (corresponding to the high-frequency power amplifier shown in FIG. 3) that is mounted to a transmitter of a cellular phone or the like. For instance, the bias control circuit is constituted by a heterojunction-bipolar transistor that is formed on a GaAs compound semiconductor (HBT) substrate and is formed into an integrated circuit together with a transistor circuit that constitutes the high-frequency power amplifier.

The GaAs-HBT has an element structure thereof having no P wells that appear in Si bipolar transistors, is constituted solely by npn transistors, and has the maximum base-emitter voltage V_{BE} of 1.4 volts. In the transistor integrated circuit constituting the bias control circuit, the GaAs-HBTs are stacked in two levels at the maximum between the DC voltage power source and the ground, so that the bias control circuit may be easily formed into an integrated circuit and may be operated with a DC power source voltage Vcc of, e.g., 3 volts supplied from a battery or the like.

Generally, a cellular phone is configured to adjust the transmission output level in accordance with a demand from a base station. Thus, a bias control circuit mounted in such a cellular phone must satisfy several requirements. First, the bias control circuit is required to have a high input impedance in the order of 10 Kohms or more so as to be properly operable with the output (control voltage V_{GC}) of a D/A converter that is provided in a cellular phone for the transmission output level adjustment. Further, the bias control circuit is required to have a low output impedance in the order of 2 ohms or less so as to control a bias current of a high-frequency power amplifier while maintaining the linearity of operation of the high-frequency power amplifier. Moreover, the bias control circuit is required to suppress a useless current below, e.g., 5 mA or less for power conservation, which current does not directly contribute to a base input current for driving transistors of the high-frequency power amplifier.

To meet these requirements, the bias control circuit is constituted by a voltage follower circuit, unlike a conventional apparatus comprised of a current mirror circuit. The bias control circuit is configured to convert the control voltage V_{GC} of a DC voltage, which varies, e.g., from 0 volt to 3 volts and is received at high input impedance, into a bias control voltage V_{OUT} of a DC voltage varying from 0 volt to 1.5 volts, and to output the bias control voltage V_{OUT} at low impedance. The bias control voltage V_{OUT} is applied to the base of a transistor in the high-frequency power amplifier, whereby the emitter current I_{E} of the transistor is adjusted in the range of 1 to 200 mA to variably control the output of the high-frequency power amplifier.

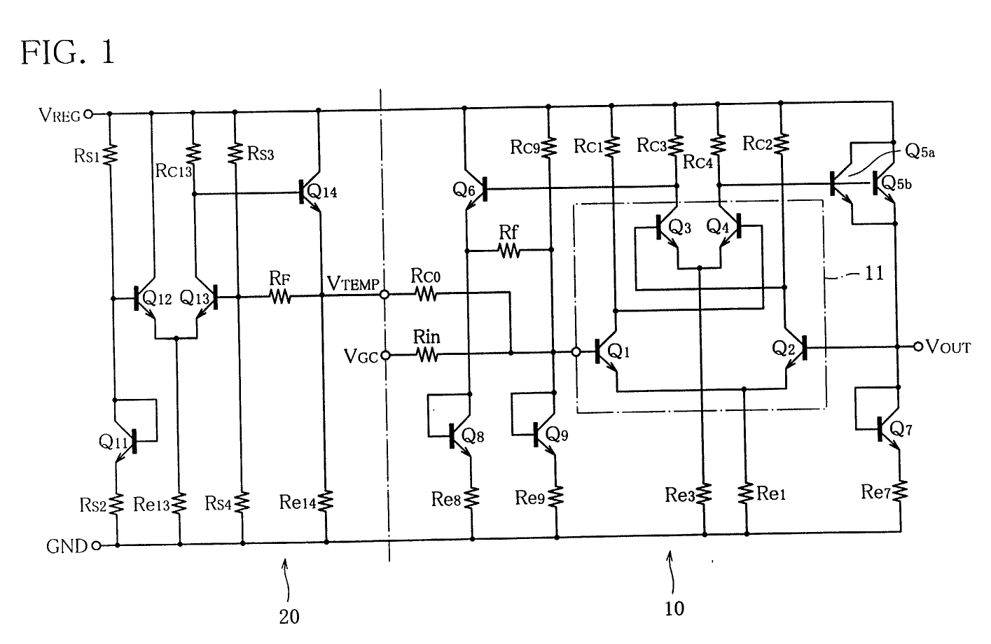

More specifically, the bias control circuit of the present embodiment is configured as shown in FIG. 1. In brief, the bias control circuit is comprised of a voltage conversion circuit 10 constituting a voltage follower circuit, and a temperature compensation circuit 20 for effecting temperature compensation for the voltage conversion circuit 10, and is formed into an integrated circuit together with the high-frequency power amplifier.

The voltage conversion circuit 10 is comprised of a two-stage high-gain differential amplifier 11 that is constituted by first and second amplifier stages. The first amplifier stage of the differential amplifier 11 is constituted by a pair of transistors Q1 and Q2, and the second amplifier stage thereof is constituted by a pair of common-emitter transistors Q3 and Q4 having bases thereof individually receiving collector outputs of the transistors Q1 and Q2. The bases of the transistors Q1 and Q2 constitute an inverting input terminal and a non-inverting input terminal of the differential amplifier 11, respectively, whereas the collectors of the transistors Q3 and Q4 respectively constitute an inverting output terminal and a non-inverting output terminal of the differential amplifier 11. Unlike an ordinary differential amplifier in which a transistor serving as a constant current source is provided between the grounding (GND) line and the emitter of a transistor constituting such a differential amplifier, the differential amplifier 11 of the bias control circuit of this embodiment, constituted by transistors which are stacked in two levels at the maximum, is provided with emitter resistors Re1 and Re3 instead of a transistor serving as a constant current source. In FIG. 1, symbols Rc1 to Rc4 denote load resistors, respectively, which are individually provided between the transistors Q1 to Q4 and the power source (V_{REG}=V_{cc}).

The bias control circuit comprises common-emitter output transistors Q5a and Q5b for subjecting the non-inverting output voltage of the differential amplifier 11 to low impedance conversion and for outputting the resulting voltage as a bias control voltage V_{OUT}, and a collector-grounded output transistor Q6 for subjecting the inverting output voltage of the differential amplifier 11 to low impedance conversion and for outputting the resulting voltage. The output transistors Q5a and Q5b are connected in parallel to each other so as to secure the output current capacity. The common emitters of the transistors Q5a and Q5b are connected to the ground line GND through a diode-connected transistor Q7 and an emitter resistor Re7 connected in series therewith, and the emitter of the transistor Q6 is connected to the ground line GND through a diode-connected transistor Q8 and an emitter resistor Re8 connected in series therewith. The transistor Q7 and the emitter resistor Re7 constitute a load for the output transistors Q5a and Q5b, and the transistor Q8 and the emitter resistor Re8 constitute a load for the output transistor Q6.

The bias control circuit further comprises a feedback circuit which serves to perform entire feedback of the output voltage (bias control voltage V_{OUT}) of the output transistors Q5a, Q5b to the non-inverting input terminal (the base of the transistor Q2) of the differential amplifier 11 and to feedback the output voltage of the output transistor Q6, corresponding to the non-inverting output voltage of the differential amplifier 11, to the non-inverting input terminal (the base of the transistor Q1) of the differential amplifier 11 through a feedback resistor Rf.

Owing to the feedback of the output voltages of the output transistors to the differential amplifier 11, in particular the entire feedback of the output transistors Q5a, Q5b to the differential amplifier 11, the output impedance of the output transistors is kept small, even if electric currents flowing through the transistors Q5a and Q5b greatly change. Thus, bias currents for the voltage conversion circuit 10 can be made sufficiently small.

In the bias control circuit, the base of the transistor Q1 of the differential amplifier 11 is connected, on one hand, to the ground line GND through a diode-connected transistor Q9 and an emitter resistor Re9 connected in series therewith, and, on the other hand, to the power source (V_{REG}) through a collector resistor Rc9. The series circuit comprised of the resistors Rc9, Re9 and the transistor Q9 regulates the base potential of the transistor Q1 to thereby set the operating point thereof. That is, the transistor Q9 serves as a biasing transistor.

Further, the base potential of the transistor Q2 of the differential amplifier 11 is directly regulated by the transistor Q7, whereby the operating point of the transistor Q2 is set. That is, in the bias control circuit, a base biasing circuit on the side of the non-inverting input terminal (the base of the transistor Q2) of the differential amplifier 11 is omitted, and the transistor Q7 constituting a load for the output transistors Q5a and Q5b serves as a biasing transistor, whereby the bias control circuit is simplified in construction.

In brief, the bias control circuit has the following basic arrangement. The bias control circuit receives the control voltage V_{GC} at the inverting input terminal (the base of the transistor Q1) of the differential amplifier 11 through an input resistor Rᵢₙ. The differential amplifier 11 amplifies the control voltage V_{GC} with an amplification gain determined by the feedback resistor Rf and the like, while making the entire feedback of the non-inverting output voltage to the non-inverting input terminal and the feedback of the inverting output voltage to the inverting input terminal through the feedback resistor Rf. The thus amplified or voltage-converted output, i.e., the non-inverting output voltage, is subject to low impedance conversion by the output transistors Q5a and Q5b and is applied as the bias control voltage V_{OUT} to the high-frequency power amplifier (specifically, to the base of the transistor Q2 constituting the high-frequency power amplifier 1 shown in FIG. 3), which is an object to be controlled by the bias control circuit.

As explained previously, the bias control circuit is requested to have a high input impedance. In order to increase the input impedance of the transistor Q1, generally, a transistor serving as a constant current source is provided between the emitter of the transistor Q1 and the ground or the transistor Q1 is constituted by a plurality of Darlington-connected transistors, or other countermeasures are taken. In the present embodiment, such a general countermeasure is not appropriate, since there is a restriction such that transistors constituting the bias control circuit be stacked in two levels at the maximum so as to permit the bias control circuit to be operable with a battery voltage and to be easily formed into an integrated circuit.

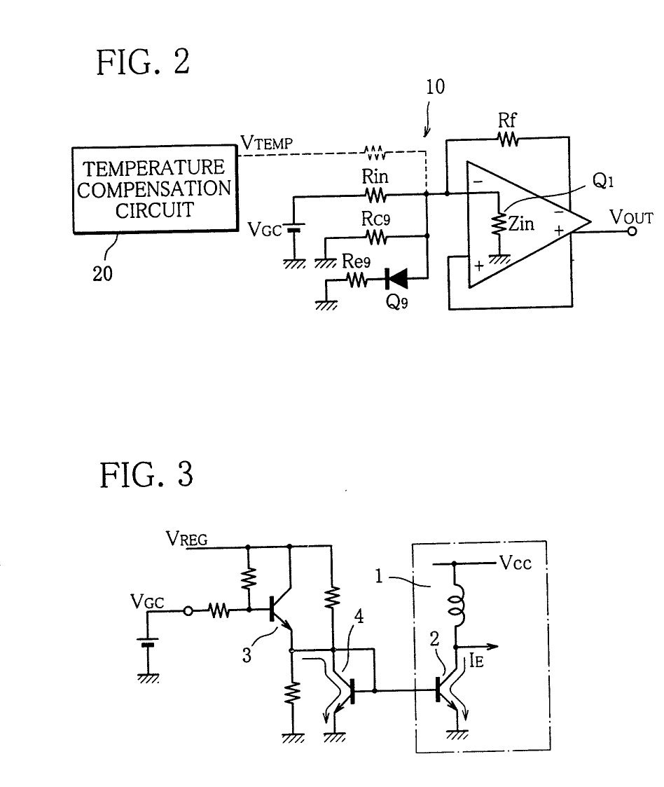

Here, referring to an equivalent circuit (FIG. 2) of the bias control circuit, the input impedance Zᵢₙ of the differential amplifier 11 is represented by the input impedance of the transistor Q1 of the differential amplifier 11. The input impedance of the transistor Q1 varies depending on the resistance of the emitter resistor Re1. Thus, in this embodiment, the resistance of the emitter resistor Re1 is increased so that the transistor Q1 may have the input impedance large enough for practical use.

The amplification gain (voltage gain) of the voltage conversion circuit 10 of the bias control circuit is determined by the input resistance at the inverting input terminal of the differential amplifier 11 and the resistance of the feedback resistor Rf. The input resistance at the inverting input terminal is represented by the composite resistance of the input resistor Rᵢₙ connected to the base of the transistor Q1 and a resistor in the base biasing circuit constituted by the transistor Q9. More specifically, as shown in FIG. 2, the input resistance is represented by the composite resistance of the input resistor Rᵢₙ, the collector resistor Rc9 for the transistor Q9, the internal resistor Zᵢₙ of the transistor Q1, and the emitter resistor Re9 for the transistor Q9. Thus, the amplification gain of the voltage conversion circuit 10 is determined by the composite resistance and the resistance of the feedback resistor Rf.

The internal resistance of the transistor Q9, serving as one of elements that determine the input resistance at the inverting input terminal of the differential amplifier 11, varies depending on temperature, as in the case of the transistors Q12 to Q4 constituting the differential amplifier 11. Therefore, the internal resistance of the transistor Q9 makes it possible to make temperature compensation of the amplifying characteristic of the differential amplifier 11 to a certain extent.

However, the temperature compensation based on the internal resistance of the transistor Q9 is achieved in a fixed manner. In some cases, the temperature characteristic of the bias control circuit (voltage conversion circuit 10) cannot be compensated in a manner conforming to the temperature characteristic of the high-frequency power amplifier that is an object to be controlled by the bias control circuit. In this respect, the bias control circuit of this embodiment comprises a temperature compensation circuit 20 which is provided independently of the voltage conversion circuit 10 in the present embodiment. The temperature compensation circuit 20 is formed into an integrated circuit together with the voltage conversion circuit 10.

As shown in FIG. 1, the temperature compensation circuit 20 comprises: a resistor bridge circuit that is constituted by a diode-connected transistor Q11 serving as a temperature sensor and four resistors Rs1 to Rs4 and that constitutes a temperature detecting circuit; a temperature-detecting amplifier, comprised of a pair of transistors Q12 and Q13, for detecting the output of the resistor bridge circuit; and a collector-grounded output transistor Q14 for subjecting the output of the temperature-detecting amplifier to low impedance conversion and for outputting the resulting output as a temperature compensating voltage V_{TEMP}. Symbols Rc13 denotes a load resistor for the temperature-detecting amplifier (transistor Q13); Re13, an emitter resistor; and Re14, an emitter resistor serving as a load for the output transistor Q14.

The temperature correcting voltage V_{TEMP} is negative fedback to the temperature-detecting amplifier through the feedback resistor R_{F}, so that the temperature-detecting operation of the temperature compensation circuit 20 may be stabilized. On the other hand, the temperature-correcting voltage V_{TEMP} is applied through the input resistor R_{CO} to the base of the transistor Q1 in the voltage conversion circuit 10, to be added to the control voltage V_{GC}. With this arrangement, the amplification gain of the temperature-detecting amplifier is set by adjusting the resistance of the feedback resistor R_{F} or the like, whereby the detected temperature-output voltage characteristic of the temperature compensation circuit 20 can be adjusted. Thus, a correcting characteristic can be freely set independently of the voltage conversion circuit 10, unlike the case where the temperature correcting function is provided in the form of, e.g., a constant current source on the emitter side of the differential amplifier 11 in the voltage conversion circuit 10. Moreover, a correcting amount can be advantageously adjusted by setting the resistance of the input resistor R_{CO}.

In summary, according to the bias control circuit of this embodiment, the bias for the transistors constituting the high-frequency power amplifier can be effectively controlled under a restriction that transistors be stacked in two levels at the maximum. Additionally, the output power of the high-frequency power amplifier is effectively variable by controlling the bias for the high-frequency power amplifier while making the temperature compensation. Moreover, the bias control circuit of this embodiment makes it possible to set the bias for the transistor Q2 of the differential amplifier 11 by means of the transistor Q7 constituting the load for the output transistors Q5a, Q5b, thereby eliminating a base biasing circuit for the transistor Q2. Thus, the bias control circuit can be advantageously simplified in circuit configuration.

Furthermore, the bias control circuit makes it possible to achieve power preservation, since it is constituted by the voltage conversion circuit 10 realized in the form of a voltage follower circuit that does not entail a useless current, which appears in a current mirror circuit and which does not directly relate to the bias control. Thus, the bias control circuit can be advantageously built into a transmitter of a cellular phone, for instance, together with a high-frequency power amplifier.

The present invention is not limited to the foregoing embodiment. In the embodiment, the arrangement has been explained in which the high-frequency power amplifier and the bias control circuit are constituted by GaAs-HBTs so as to be operable with the power source voltage of 3 volts. A bias control circuit operable with the power source voltage of 1.5 volts can be constituted by Si-transistors, e.g., SiGe-HBTs, whose maximum base-emitter voltage V_{BE} is 0.7 volts. Instead of the two output transistors Q5a and Q5b, a single output transistor or parallel-connected output transistors may be used in accordance with the base current required by the high-frequency power amplifier. In other respects, the present invention can be modified variously within the scope of the inventive concept thereof.

What is claimed is:

1. A bias control circuit for controlling a bias current of a high-frequency power amplifier, comprising:
a voltage conversion circuit for receiving a control voltage and for converting the control voltage into a bias control voltage to be supplied to the high-frequency power amplifier, said voltage conversion circuit includes:
a two-stage differential amplifier, constituted by two pairs of amplifying transistors and having an inverting input terminal, a non-inverting input terminal, an inverting output terminal and a non-inverting output terminal, for receiving the control voltage at the inverting input terminal and for outputting an inverting output voltage and a non-inverting output voltage from the inverting output terminal and the non-inverting output terminal, respectively;
an output transistor for effecting low impedance conversion for the non-inverting output voltage of the two-stage differential amplifier to obtain an output voltage and for outputting the thus obtained output voltage, as the bias control voltage, to the high-frequency power amplifier;
a feedback circuit for making entire feedback of the output voltage to the non-inverting input terminal of the two-stage differential amplifier and for making feedback of the inverting output voltage of the two-stage differential amplifier to the inverting input terminal thereof; and
a diode-connected biasing transistor for regulating base voltages of the pair of amplifying transistors constituting a first amplifier stage of the two-stage differential amplifier.

2. The bias control circuit according to claim 1, wherein said high-frequency power amplifier for use with the bias control circuit is comprised of a transistor.

3. The bias control circuit according to claim 2, wherein said high-frequency power amplifier is configured to have output power that varies in accordance with a base-emitter voltage applied to the transistor constituting the high-frequency power amplifier, and the bias control circuit optimally controls the bias current of the high-frequency power amplifier so that desired output power corresponding to the control voltage is output from the high-frequency power amplifier.

4. The bias control circuit according to claim 2, wherein said bias control circuit is comprised of a transistor integrated circuit and is formed into an integrated circuit together with the transistor constituting the high-frequency power amplifier.

5. The bias control circuit according to claim 4, wherein said bias control circuit is constituted by a transistor integrated circuit that is operable with a DC power source voltage of 1.5 or 3.0 volts.

6. The bias control circuit according to claim 5, wherein at least part of the transistor integrated circuit constituting the bias control circuit is comprised of transistors that are configured to have a maximum base-emitter voltage which is approximately half the DC power source voltage supplied from a battery.

7. The bias control circuit according to claim 6, wherein the at least part of the transistor integrated circuit constituting the bias control circuit is constituted by heterojunction-bipolar transistors whose maximum base-emitter voltage is approximately 1.4 volts.

8. The bias control circuit according to claim 6, wherein the at least part of the transistor integrated circuit constituting the bias control circuit is constituted by Si bipolar transistors whose maximum base-emitter voltage is about 0.7 volts.

9. The bias control circuit according to claim 1, further comprising a temperature compensation circuit for applying a temperature compensation voltage to the inverting input terminal of the two-stage differential amplifier.

10. The bias control circuit according to claim 9, wherein said temperature compensation circuit comprises:
a resistor bridge circuit including a diode-connected temperature-sensing transistor connected in series therewith;
an error amplifier, comprised of a pair of amplifying transistors, for amplifying a bridge output of the resistor bridge circuit to obtain an error voltage; and
an output transistor for effecting low-impedance conversion of an output voltage of the error amplifier, to thereby generate a temperature compensation voltage.

11. The bias control circuit according to claim 9, wherein said temperature compensation circuit and the voltage conversion circuit are each constituted by a transistor integrated circuit, and the temperature compensation circuit is formed into an integrated circuit together with the voltage conversion circuit.
